(19) United States
(12) Patent Application Publication
(10) Pub. No.: US 2022/0148351 A1
(43) Pub. Date: May 12, 2022

(54) INFORMATION PROCESSING SERVER, INFORMATION PROCESSING METHOD, STORAGE MEDIUM, AND SERVICE PROVISION SUPPORT SYSTEM

(71) Applicant: HONDA MOTOR CO., LTD., Tokyo (JP)

(72) Inventors: Hodaka Mukohara, Tokyo (JP); Shumpei Suzuki, Tokyo (JP); Kobue Nose, Tokyo (JP)

(73) Assignee: HONDA MOTOR CO., LTD., Tokyo (JP)

(21) Appl. No.: 17/582,050

(22) Filed: Jan. 24, 2022

Related U.S. Application Data
(63) Continuation of application No. PCT/JP2019/029475, filed on Jul. 26, 2019.

(51) Int. Cl. G07C 5/08; G06Q 10/06

(52) U.S. Cl. CPC G07C 5/0841; G06Q 10/06311

(57) ABSTRACT

An information processing server sets a target evaluation value which is an evaluation value necessary for a user to receive provision of a specific product or a specific service, and sets one or more tasks to be processed by the user and a task evaluation value which is an evaluation value obtained by processing of each task. The information processing server imparts the task evaluation value to the user according to a processing status of a task by the user, calculates an achievement degree of an accumulated value of the task evaluation values imparted to the user with respect to the target evaluation value, and provides information regarding the achievement degree to a communication device used by the user or a service provider.

### CROSS-REFERENCE TO RELATED APPLICATION(S)

This application is a continuation of International Patent Application No. PCT/JP2019/029475 filed on Jul. 26, 2019, the entire disclosure of which is incorporated herein by reference.

### TECHNICAL FIELD

The present invention relates to an information processing server, an information processing method, a storage medium, and a service provision support system.

### BACKGROUND ART

Conventionally, there is known a technique of evaluating a driving mode of a user on the basis of a signal of a gyro sensor or the like of a vehicle, imparting an evaluation value according to the evaluation result, and providing the user with a service (for example, a discount of a vehicle rental cost or a maintenance cost) according to an accumulated value of the evaluation values (PTL 1). With such a technique, the discount of the rental cost and the discount of the maintenance cost are provided to a user who has performed safe driving, so that the consciousness of the user for safe driving can be improved.

### CITATION LIST

### Patent Literature

PTL 1: Japanese Patent Laid-Open No. 2015-87928

### SUMMARY OF INVENTION

### Technical Problem

Incidentally, in a case where a service is set to be provided according to an action of the user of the vehicle, there is a case where it is desirable to evaluate the action of the user not only from the action of the user related to safe driving but also from various aspects and provide a service according to the evaluation result. In this regard, in the technique disclosed in PTL 1, the action of the user to be evaluated is limited to the action related to safe driving, and an evaluation on an action other than the action related to safe driving has not been considered.

The present invention has been made in view of the above problems, and an object of the present invention is to implement a technique that enables a service provider to provide a flexible service to a user on the basis of evaluation on an action of the user.

### Solution to Problem

According to the present invention, there is provided an information processing server including: a target evaluation value setting unit that sets a target evaluation value which is an evaluation value necessary for a user to receive provision of a specific product or a specific service; a task setting unit that sets one or more tasks to be processed by the user and a task evaluation value which is an evaluation value obtained by processing of each task; an imparting unit that imparts the task evaluation value to the user according to a processing status of a task by the user; an achievement degree calculation unit that calculates an achievement degree of an accumulated value of the task evaluation values imparted to the user with respect to the target evaluation value; and a providing unit that provides information regarding the achievement degree to a communication device used by the user or a service provider.

### Advantageous Effects of Invention

According to the present invention, a service provider can provide a flexible service to a user on the basis of an evaluation on an action of the user.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a diagram illustrating an example of a service provision support system according to the present embodiment of the present invention.

FIG. 2 is a block diagram illustrating a functional configuration example of an information processing server according to the present embodiment.

FIG. 3 is a block diagram illustrating an example of a software configuration of the information processing server according to the present embodiment.

FIG. 4 is a block diagram illustrating a functional configuration example of a user communication device according to the present embodiment.

FIG. 5 is a block diagram illustrating a functional configuration example of a service-provider communication device according to the present embodiment.

FIG. 6 is a sequence diagram illustrating an outline of operations by the user communication device and the information processing server according to the present embodiment.

FIG. 7A is a flowchart illustrating a series of operations of a user evaluation management process according to the present embodiment.

FIG. 7B is a flowchart illustrating a series of operations of the user evaluation management process according to the present embodiment.

FIG. 8 is a diagram illustrating an example of a data structure of set task information according to the present embodiment.

FIG. 9 is a diagram illustrating an example of a data structure of user evaluation value information according to the present embodiment.

FIG. 10 is a diagram illustrating an example of a data structure of payment information according to the present embodiment.

FIG. 11 is a diagram illustrating an example of a data structure of action history information according to the present embodiment.

FIG. 12 is a diagram illustrating an example of a product/service selection screen according to the present embodiment.

FIG. 13 is a diagram illustrating an example of an achievement degree display screen according to the present embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

[System Outline]

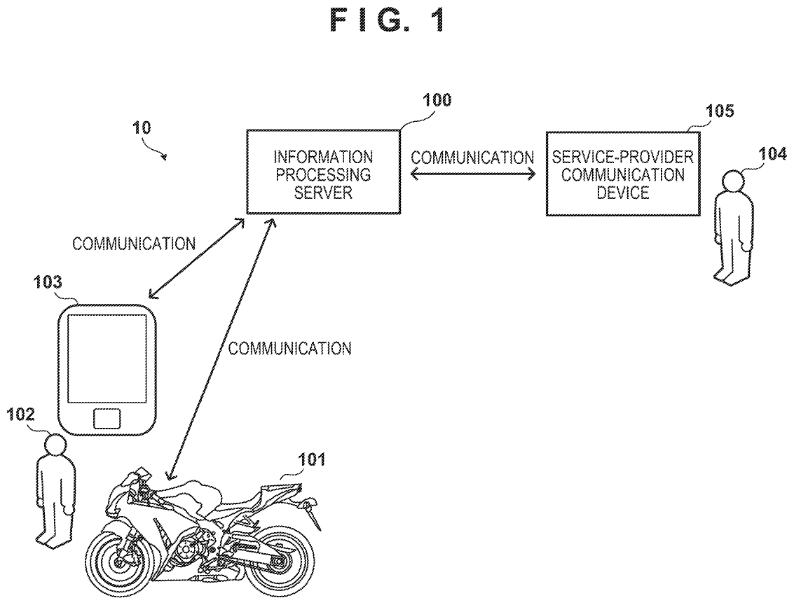

FIG. 1 is a diagram illustrating a configuration example of a service provision support system according to the present embodiment. A service provision support system 10 according to the present embodiment includes an information processing server 100 and a user communication device 103 used by a user 102. Furthermore, the service provision support system 10 may further include at least one of a service-provider communication device 105 used by an operator 104 of service provider dealers and a vehicle 101 driven by the user 102.

The information processing server 100 is a server managed by the service provider, and performs a user evaluation management process described later to manage setting of a task for the user 102 and a processing status of the task by the user 102. The task will be described later. When the user 102 processes (executes) the set task, an evaluation value (referred to as a task evaluation value) determined for each task is imparted to the user 102. That is, the information processing server 100 imparts the task evaluation value to the user according to the processing status of the task by the user.

The service provider is a provider that provides services to users and other customers, and for example, rents a vehicle to the user 102, provides a maintenance service of the vehicle, or sells parts of the vehicle. In the present embodiment, the service provider rents the vehicle 101 to the user 102. The user 102 pays, to the service provider, a consideration for the rent (rental cost) for each predetermined period (for example, every day, every week, every month).

The service provider can provide various services such as a taxi service by the user 102 and a package delivery service by the user 102 to customers other than the user 102, for example. These various services may be implemented when the service provider sets various tasks (for example, the transportation of customers or the delivery of baggage) for the user 102, and the user processes the set tasks. The task set for the user may be determined by various methods, and for example, when the evaluation (for example, a task evaluation value, a point, or another evaluation index) of the user 102 accumulated by the user 102 processing the task is higher, a task of a type that requires higher reliability can be set.

The task evaluation value can be treated as, for example, a point to be imparted to the user 102, and imparting the task evaluation value to the user 102 may be synonymous with imparting the point to the user 102. Of course, the present invention is not limited to this example, and the task evaluation value and the point may be treated as separate values, and the task evaluation value may be converted into the point after the task evaluation value is imparted to the user. The point is a transaction unit that can be used for predetermined payment by the user 102. The point can be converted into the currency of a country in which the service is provided, but is not the currency itself. This point can be used, for example, for payment of the rental cost of the vehicle rental service by the service provider, and the user who has accumulated the point can substantially reduce the rental cost of the vehicle rental service by using the point. Furthermore, the point can be used for not only the payment of the rental cost of the vehicle but also the payment of the maintenance cost of the vehicle. Alternatively, in a case where the vehicle can be purchased, the point may be used for payment of the consideration for the purchase. Virtual currency issued and managed by the service provider may be used as the point that can be used for payment. The virtual currency may be, for example, currency that is not linked to currency to be used for ordinary transactions in terms of currency value. Of course, general-purpose virtual currency other than the virtual currency issued by the service provider may be used.

The task defines an action to be processed (executed) by the user. In a case where the service provider provides the user with a vehicle rental service, the payment of the rental cost may be one task. Furthermore, in a case where the service provider provides a taxi service, for example, an action of “receiving wage payment, picking up a customer, and driving the vehicle 101 to a target value” can also be one task. Furthermore, the task may include an action of taking a picture of the traffic situation at a predetermined time and place with the user communication device 103, and an action of transmitting weather information of a place where the user is acting from the user communication device 103. The task may not be the action associated with the vehicle, and may be any action directly or indirectly associated with the service provided by the service provider.

The vehicle 101 is, for example, a two-wheeled vehicle, and can carry one customer in addition to the user 102 who is a driver. The vehicle 101 may be able to communicate with the information processing server 100, and can transmit data (also referred to as traveling data), such as accelerations collected by a sensor of the vehicle 101, to the information processing server at any time or at a predetermined timing. The traveling data will be described below. The information processing server 100 may use the acquired traveling data to calculate the evaluation value of the user 102. Note that a case where the vehicle 101 is a two-wheeled vehicle will be described as an example in the present embodiment, but the vehicle 101 may be a four-wheeled vehicle.

The user communication device 103 is, for example, a smartphone owned by the user 102 or rent by the service provider, and can communicate with the information processing server 100 via a communication network. By using the communication device 103, the user 102 can select a task to be processed by the user, input a processing result of the task, or check a task evaluation value accumulated in the user. Furthermore, in a case where the user 102 uses the vehicle 101 in a taxi service, the user 102 or a customer of the service can input an evaluation for driving of the user 102 via the user communication device 103 and transmit information regarding the evaluation to the information processing server 100. Furthermore, the user 102 can communicate with, for example, a server for online payment (not illustrated) or the like by using the communication device 103, and perform payment processing for a purchased product or payment processing for a fare of a taxi service.

The service-provider communication device 105 is a communication device used by the service provider, and is, for example, a personal computer. The service-provider communication device 105 can acquire the user information such as the accumulated value of the task evaluation values imparted to the user 102 from the information processing server 100 by the operation of the operator 104 and display the acquired information.

[Functional Configuration Example of Information Processing Server]

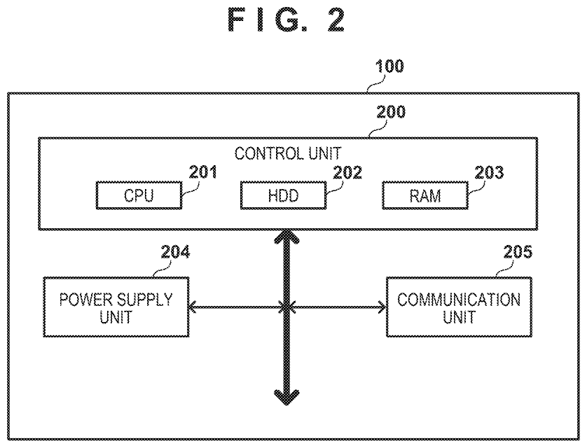

FIG. 2 is a block diagram illustrating a functional configuration example of the information processing server 100. A control unit 200 includes one or more processors (central processing unit (CPU) 201), a hard disc drive (HDD) 202, and a random access memory (RAM) 203. The CPU 201 reads and executes a computer program (simply referred to as a program) stored in the HDD 202 to control various types of processing to be described below. The HDD 202 is a non-volatile storage area, and stores programs corresponding to the various types of processing. Note that a semiconductor memory may be used instead of the HDD. The RAM 203 is a volatile storage area, and is used as, for example, a working memory. Note that the control unit 200 may include a graphics processing unit (GPU), an application specific integrated circuit (ASIC), a dedicated circuit, or the like. Furthermore, the control unit 200 may be configured such that each constituent element of the control unit 200 is virtualized.

A power supply unit 204 is a part that supplies external power to the information processing server 100. A communication unit 205 is a part for communicating with the vehicle 101, the user communication device 103, and the like via a communication network, and is not particularly limited in terms of a communication method, a communication protocol, and the like.

[Software Configuration of Information Processing Server]

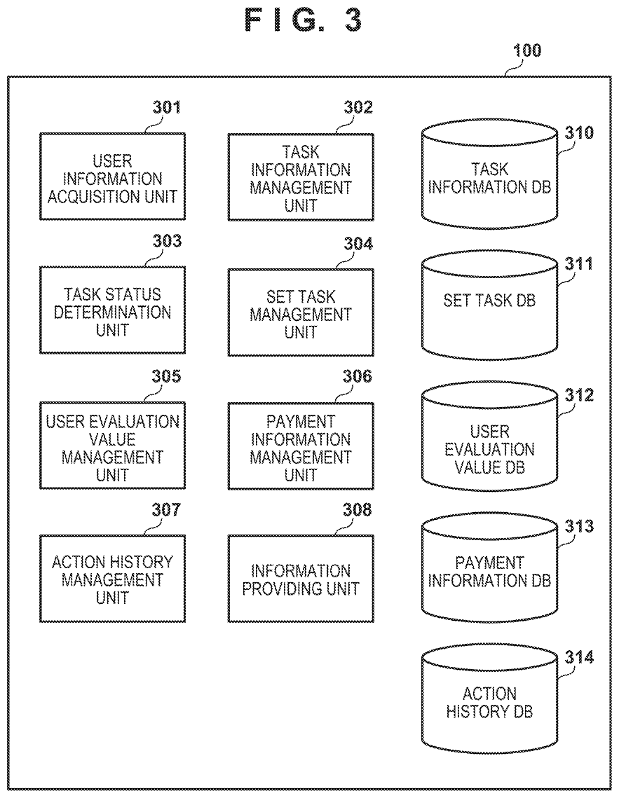

FIG. 3 is a diagram illustrating an example of a software configuration of the information processing server 100 according to the present embodiment. In the present embodiment, the CPU 201 reads and executes a program stored in the HDD 202 or the like to implement each unit. Each database (DB) is included in the HDD 202. Note that FIG. 3 illustrates only an example of the software configuration necessary for implementation of the present embodiment, so that each software configuration of firmware, OS, middleware, a web service module, and the like is omitted.

A user information acquisition unit 301 acquires user information from the vehicle 101 and the user communication device 103 via the communication unit 205. The user information includes information of a processing result of a task received from the user communication device 103, payment information of the user, traveling data uploaded from the vehicle 101, and the like. Furthermore, in a case where the user 102 uses the vehicle 101 in a taxi service, the user information further includes information regarding evaluation input for the driving of the user 102 via the user communication device 103.

A task information management unit 302 reads the task information stored in a task information DB 310 or updates the task information for each user in a set task DB 311 by setting the task evaluation value for each task. The task information DB 310 is a database that stores information (task information) of a predetermined task. As described above, the task includes the payment of a rental cost, an action of receiving wage payment, picking up a customer, and driving the vehicle 101 to a target value, or the like.

A task status determination unit 303 determines the processing status of the task for each user on the basis of the information of the task set for each user stored in the set task DB 311. Furthermore, information of a processing result of a task in the user information acquired by the user information acquisition unit 301 is processed to determine a task status, or payment information of the user 102 is processed to determine a task status.

A set task management unit 304 manages a task for each user. The set task management unit 304 reads the information of the task set for each user from the set task DB 311 or changes the task information of the set task DB 311 (for example, sets a task evaluation value for the task set for the user). The set task DB 311 is a database that stores task information set for each user. The task information set for each user (set task information) will be described later.

The user evaluation value management unit 305 reads or changes the evaluation information of each user stored in the user evaluation value DB 312. The user evaluation value DB 312 is a database that stores user evaluation value information set for each user. The user evaluation value information is information including a target evaluation value, an accumulated value of task evaluation values, and the like. The user evaluation value information will be described later.

A payment information management unit 306 writes information regarding the payment made by the user in the payment information DB 313 or reads payment information stored in the payment information DB 313 on the basis of the information of the processing result of the task included in the user information acquired by the user information acquisition unit 301. The payment information DB 313 is a database that stores payment information for each user. The payment information will be described later.

An action history management unit 307 writes information regarding the action history of the user in an action history DB 314 or reads action history information stored in the action history DB 314 on the basis of traveling data included in the user information acquired by the user information acquisition unit 301. The action history DB 314 is a database that stores action history information for each user. The action history information will be described later.

[Set Task Information]

As described above, for example, the set task management unit 304 sets the task evaluation value for the task set by the user and changes the task information in the set task DB 311.

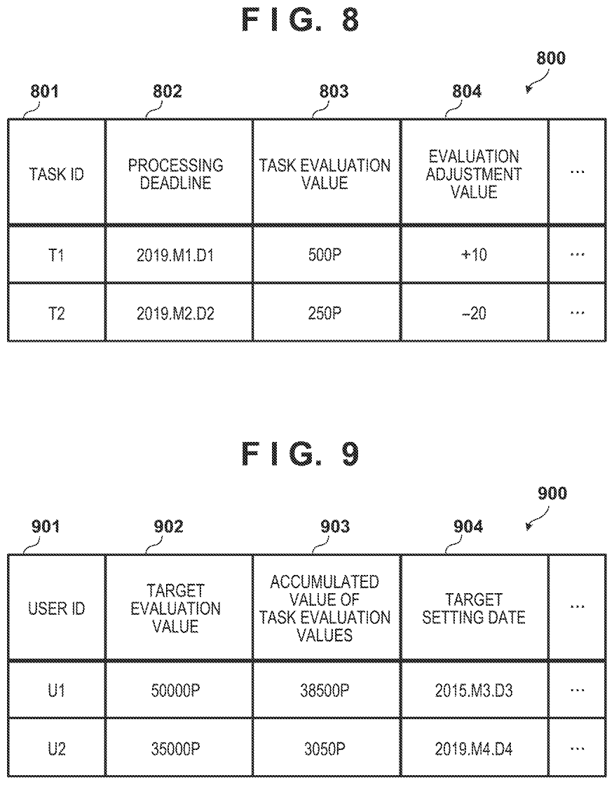

For example, as illustrated in FIG. 8, the set task information stored in the set task DB 311 includes information such as a task ID 801, a processing deadline 802, a task evaluation value 803, and an evaluation adjustment value 804. The set task information illustrated in FIG. 8 is managed for each user ID. The task ID 801 is identification information for uniquely identifying the task. The task set by the user includes information of the processing deadline 802, and specifies by when the task is to be processed. The task evaluation value 803 is an evaluation value indicating how much value is imparted to the user in a case where the user processes the task. The task evaluation value may be determined in advance for each task. For example, in a case where the service provider provides a vehicle rental service to the user 102, the user 102 is imparted a task evaluation value of a predetermined value every time the user makes one payment of the rental cost. Furthermore, for example, in a case where the service provider provides a taxi service, for example, when the user finishes a task of “receiving wage payment, picking up a customer, and driving the vehicle 101 to a target value”, a corresponding task evaluation value is imparted.

Note that the task may have an attribute indicating that processing is “required” or that processing is “optional”.

The evaluation adjustment value 804 is an adjustment value for varying the task evaluation value 803 imparted to each task according to the task processing status of the user. For example, in a case where the processing status of a specific type of task of the user (for example, the same or the same type of task) is in a state where the number of processing times is small, the information processing server 100 can increase the evaluation adjustment value of the set task for the user (set the evaluation adjustment value 804 to a positive value) for the task of the specific type of the user. In this way, it is possible to prompt the user to perform future processing of the corresponding task (according to the processing status of the past task).

The evaluation adjustment value 804 may be adjusted according to the task processing status of the user himself/herself for which the task is set, and further may be set according to the processing status of a specific type of task of another user. For example, for a predetermined task which is less processed by another user, the user can be prompted to process the task when the evaluation adjustment value 804 of the set task for the user is set to a positive value.

[User Evaluation Value Information]

The user evaluation value information is set for each user and stored in the user evaluation value DB 312. For example, as illustrated in FIG. 9, the user evaluation value information includes a user ID 901, a target evaluation value 902, an accumulated value 903 of the task evaluation values, and a target setting date 904.

The user ID is identification information for uniquely identifying the user. The target evaluation value 902 is an evaluation value necessary for each user to obtain a specific product or a specific service. The target evaluation value is, for example, a target value of (an accumulated value of) a task evaluation value with which the user can obtain a vehicle, that is, the vehicle can be owned by the user in a case where the user processes a task of renting the vehicle and paying daily rental costs. The task target value may be set in advance for each specific product or specific service that the user intends to obtain. For example, different target evaluation values may be set according to the model of a two-wheeled vehicle which is rented to the user.

The accumulated value 903 of the task evaluation values represents an accumulated value of the task evaluation values (that is, the task evaluation values 803) obtained each time the user processes the task. In the above-described vehicle rental example, when the accumulated value 903 of the task evaluation values becomes equal to or more than the target evaluation value 902, the user can obtain the vehicle. The target setting date 904 represents a date on which the target evaluation value 902 is set. By using the target setting date 904, it is possible to set a limit for the accumulated value 903 of the task evaluation values to be equal to or more than the target evaluation value 902.

Although not illustrated in FIG. 9, the information of the task for which the user completes processing may be stored in the user evaluation information. Furthermore, in a case where the user provides a taxi service to a customer on board and acquires a qualitative evaluation value from the customer (via the user communication device 103), the accumulated value of the qualitative evaluation values acquired for each user may be stored. The qualitative evaluation information is acquired for each driving and accumulated in the qualitative evaluation values so far. The qualitative evaluation value includes quantified information represented as evaluation values, such as information on manners that the user has, information as to whether the user has had an accident, and information as to whether the driver has ignored a red light. Specifically, the qualitative evaluation information includes the driver's attitude (for example, 1 to 5 points), the way the driver treats the passenger (for example, 1 to 5 points), the driver's behavior (for example, 1 to 5 points), whether the driver was wearing a helmet (for example, 0 or 1 point), and whether the driver has caused an accident while driving (for example, 0 or 1 point). In addition, the qualitative evaluation information may further include information as to whether the driver has driven through a red light (for example, 0 or 1 point). The accumulated value of the qualitative evaluation values may be added to the accumulated value 903 of the task evaluation value, or may be used for an independent purpose of selecting a new task of the user.

[Payment Information]

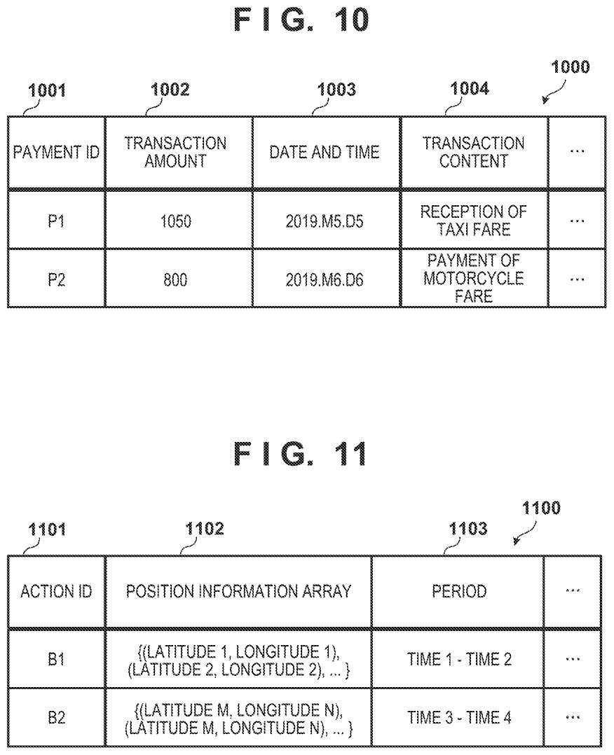

The payment information is managed for each user, and includes, for each user, a payment ID 1001, a transaction amount 1002, a date and time 1003, and a transaction content 1004, for example, as illustrated in FIG. 10. The payment information is information of money transfer such as the payment or fare reception performed by the user in the user communication device 103, and the information processing server 100 acquires the information from the user communication device 103 and stores the information in the payment information DB 313.

The payment ID 1001 is identification information for uniquely specifying payment, and is imparted by the payment information management unit 306 using a known method, for example. The transaction amount 1002 is, for example, a taxi fare or a vehicle rent. The date and time 1003 is information indicating the date and time of payment. The transaction content 1004 is text information indicating the contents of payment such as reception of a taxi fare and payment of a vehicle rent. The transaction amount 1002, the date and time 1003, and the transaction content 1004 store, for example, the information acquired from the user communication device 103.

[Action History Information]

The action history information is managed for each user, and includes, for each user, an action ID 1101, a position information array 1102, and a period 1103, for example, as illustrated in FIG. 11. The action history information is generated when traveling data is acquired from the vehicle 101.

The traveling data may include a starting time and an ending time of the drive of the user, time-series data indicating a transition of the position of the vehicle between the starting time and the ending time, time-series data indicating a transition of the speed of the vehicle between the starting time and the ending time, and time-series data indicating a transition of the acceleration of the vehicle between the starting time and the ending time. In addition, information indicating whether the vehicle has traveled without maintenance in an appropriate period may be added to the traveling data.

In the action history information illustrated in FIG. 11, the time-series data indicating a transition of the position of the vehicle in the traveling data is stored in the position information array 1102. In addition, in the period 1103, a set of starting time and ending time in the traveling data is stored.

[Functional Configuration Example of User Communication Device 103]

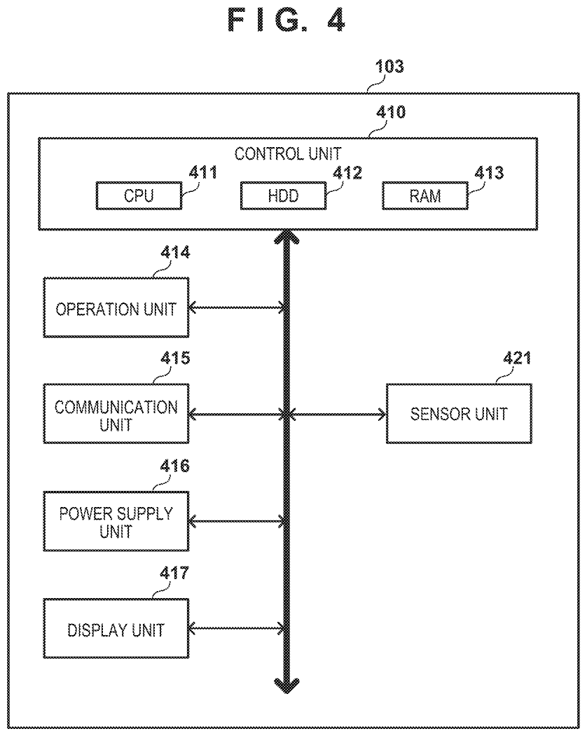

Next, a functional configuration example of the user communication device 103 will be described. FIG. 4 is a block diagram illustrating the functional configuration example of the user communication device 103. A control unit 410 includes one or more CPUs 411, an HDD 412, and a RAM 413. The CPU 411 reads and executes programs stored in the HDD 412 to control various types of processing in the communication device. The HDD 412 is a non-volatile storage medium and stores programs corresponding to the various types of processing. Note that a semiconductor memory may be used instead of the HDD. The RAM 413 is a volatile storage medium, and is used as, for example, a working memory. Note that the control unit 410 may include a GPU, an ASIC, a dedicated circuit, or the like.

The user communication device 103 according to the present embodiment includes an interface of information for the outside and various parts that provide power necessary for the operation of the user communication device 103 and the like. Each part to be described below operates under the control of the control unit 410. An operation unit 414 is a part that receives various operations on the communication device, and includes, for example, a switch, a touch panel, and the like. In the present embodiment, for example, the operation unit 414 receives selection of a task to be processed by the user himself/herself, input of a processing result of the task, an operation for transaction of a rental cost or a taxi fare, and the like.

A communication unit 415 is a part for communicating with an external device (for example, the information processing server 100) via a network, and is not particularly limited in terms of a communication method, a communication protocol, and the like. For example, the communication unit 415 transmits information of the selected task and the processing result of the task to the information processing server 100 or receives information of an achievement degree based on execution of the task.

A power supply unit 416 is a part that supplies power to each unit of the user communication device 103 and corresponds to a battery. A display unit 417 is a part for outputting various types of information such as an operation menu, map data for navigation, and passenger drive costs, and includes a display and the like. The display unit 417 and the operation unit 414 may be integrally configured as, for example, a touch panel display.

A sensor unit 421 includes various sensors such as a global positioning system (GPS) for detecting its own position information and a camera.

[Functional Configuration Example of Service-Provider Communication Device 105]

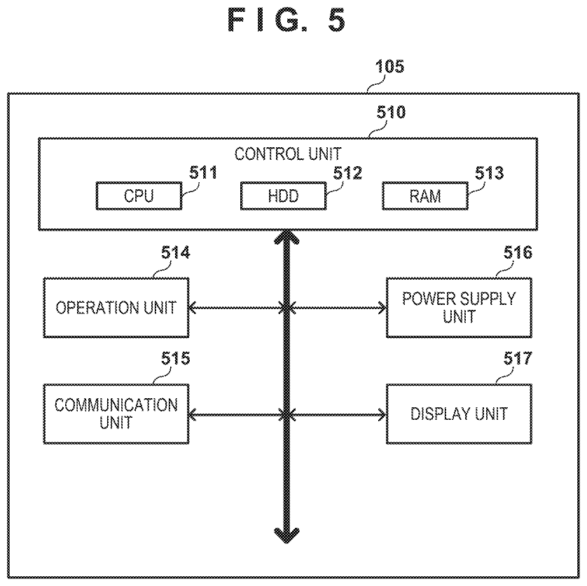

Next, a functional configuration example of the service-provider communication device 105 will be described. FIG. 5 is a block diagram illustrating a functional configuration example of the service-provider communication device 105. A control unit 510 includes one or more CPUs 511, an HDD 512, and a RAM 513. The CPU 511 reads and executes programs stored in the HDD 512 to control various types of processing in the communication device. The HDD 512 is a non-volatile storage medium and stores programs corresponding to the various types of processing. Note that a semiconductor memory may be used instead of the HDD. The RAM 513 is a volatile storage medium, and is used as, for example, a working memory.

The service-provider communication device 105 according to the present embodiment includes an interface of information for the outside and various parts that provide power necessary for the operation of the service-provider communication device 105, and the like. Each part to be described below operates under the control of the control unit 510.

An operation unit 514 is a part that receives various operations on the communication device, and includes, for example, a mouse, a keyboard, a touch panel, and the like. In the present embodiment, the operation unit 514 receives an operation of displaying the information of the user, for example, an operation of displaying the achievement degree of the accumulated value of the task evaluation values of the user with respect to the target evaluation value, an operation of displaying the user status, or the like.

A communication unit 515 is a part for communicating with an external device (for example, the information processing server 100) via a network, and is not particularly limited in terms of a communication method, a communication protocol, and the like. For example, the communication unit 515 transmits a command for requesting the information of the user to the information processing server 100 or receives display information and the like regarding the user from the information processing server 100.

A power supply unit 516 is a part that supplies power to each unit of the service-provider communication device 105 and corresponds to a battery. A display unit 517 is a part for outputting various types of information such as an operation menu, and includes a display and the like.

[Configuration of Vehicle 101]

Although the configuration of the vehicle 101 is not illustrated, the vehicle 101 includes a control unit including one or more CPUs, a storage medium such as an HDD, and a RAM, various sensors such as a GPS and an acceleration sensor, and a communication unit capable of performing wireless communication. The CPU of the vehicle 101 reads and executes programs stored in a recording medium, thereby transmitting data acquired from the sensors in the vehicle as traveling data (via the communication unit) to the information processing server 100.

[Outline of Operations by User Communication Device and Information Processing Server]

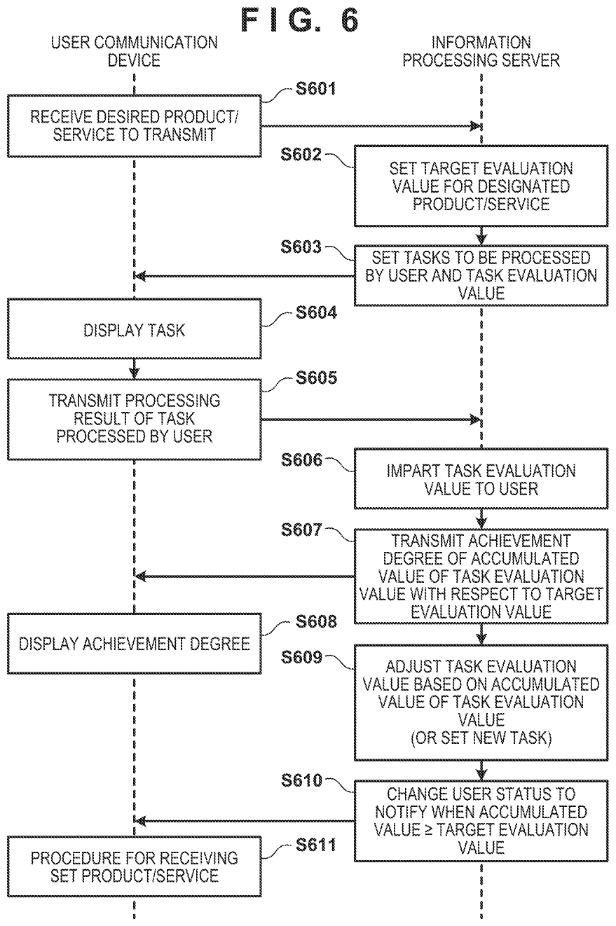

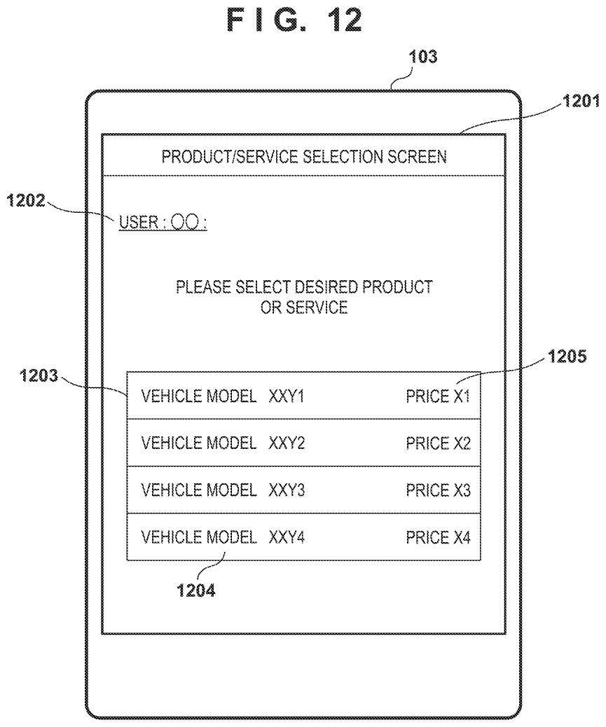

Next, an outline of operations by the user communication device and the information processing server for executing the user evaluation management process will be described with reference to a sequence diagram illustrated in FIG. 6. Note that this sequence is started from a state in which the “product/service selection screen” illustrated in FIG. 12 is displayed on the display unit 417 of the user communication device 103.

In S601, when the user designates a desired product/service (for example, a specific vehicle “XXY1”), the user communication device 103 receives the designated product and transmits information of the designated product to the information processing server 100. Note that the user communication device 103 acquires a list of products/services selectable by the user from the information processing server 100, and causes a product/service selection screen 1201 to display the list. As illustrated in FIG. 12, a user name 1202 and a products/services list 1203 are displayed on the product/service selection screen 1201. A product name 1204 and a price 1205 are displayed in each item of the products/services list 1203. The price 1205 may be displayed in the currency of the region in which the service is implemented. Instead of representing the value by currency, the price 1205 may display a target evaluation value that is an evaluation value necessary for obtaining the product/service.

In S602, the information processing server 100 receives the information indicating the selection result of the product/service (for example, the vehicle “XXY1”) designated in the user communication device 103. Then, the designated product/service is associated with the user on the basis of the information, and a target evaluation value for the product/service is set.

In S603, the information processing server 100 sets a task to be processed by the user and a task evaluation value, and transmits the task and the task evaluation value to the user communication device 103.

In S604, the user communication device 103 receives the information of the task set for the user himself/herself from the information processing server 100, and displays the information of the task on the display unit 417 so that the user can browse the task.

Thereafter, when the user processes the task, in S605, the user communication device 103 receives a processing result of the task processed by the user and transmits the processing result to the information processing server 100. For example, in a case where a task of performing maintenance of the vehicle is set for the user, and the user finishes the maintenance of the vehicle, the user inputs information such as the content of the maintenance, the price, and the date and time to the user communication device 103. The user communication device 103 transmits the input information to the information processing server 100.

In S606, when receiving the processing result of the task, the information processing server 100 checks and analyzes the received processing result and imparts, to the user, a task evaluation value associated with the task for which the processing has ended. For example, in a case where the processing of a task having a task ID “T1” among the tasks illustrated in FIG. 8 is completed, the task evaluation value 803 of 500P is imparted to the user. In other words, the information processing server 100 adds the imparted user evaluation value to the accumulated value of the task evaluation values of the user (the accumulated value 903 of the user evaluation value information).

In S607, the information processing server 100 calculates an achievement degree of the accumulated value of the task evaluation values of the user with respect to the target evaluation value, and transmits the calculated achievement degree to the user communication device 103.

In a case where a plurality of tasks are set, the achievement degree of the sum of the task evaluation values obtained by the processing of the tasks with respect to the target evaluation value is calculated.

When transmitting the information of the achievement degree to the user communication device 103, the information processing server 100 may transmit information such as the user name, the target evaluation value, the content of the product/service desired by the user, and the expected achievement time together. Furthermore, such information of the achievement degree can also be transmitted to the service-provider communication device 105 when an acquisition request is received from the service-provider communication device 105.

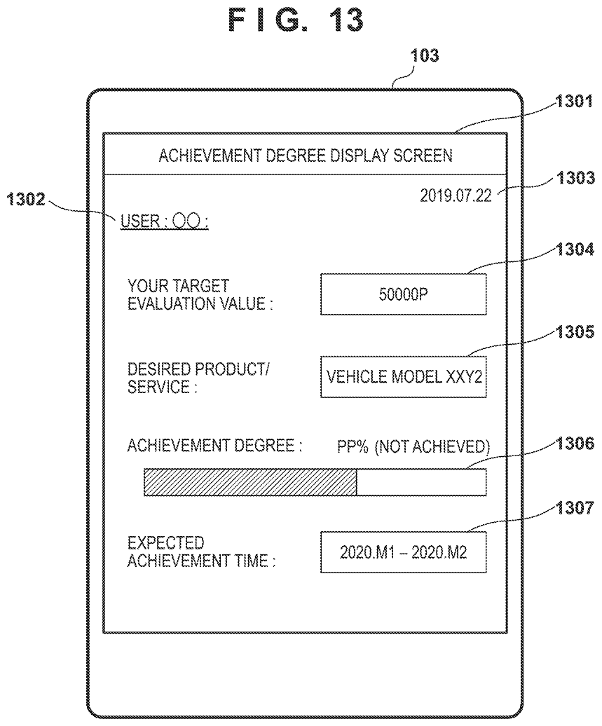

In S608, the user communication device 103 causes the display unit 417 to display the information of the achievement degree received from the information processing server 100. The information displayed on the display unit 417 by the user communication device 103 is presented, to the user, as a display screen as illustrated in FIG. 13, for example.

On an achievement degree display screen 1301 illustrated in FIG. 13, a name 1302 of the target user and a date 1303 of today are displayed. Furthermore, a target evaluation value 1304 set for the user and a product/service 1305 desired by the user are displayed. Then, an achievement degree 1306 of the accumulated value of the task evaluation values accumulated by the user processing the task with respect to the target evaluation value which allows the acquisition of the product/service is displayed. With these displays, the user can visually grasp the target value and the current achievement degree in order to obtain the product/service desired by the user, and a motivation to process more tasks can be enhanced.

The achievement degree display screen 1301 further displays an expected achievement time 1307. The expected achievement time 1307 is information related to a guide for achieving the target evaluation value, and indicates a time when the user is expected to acquire a task evaluation value exceeding the target evaluation value. The expected achievement time 1307 may display an expected date such as “which month and date”, or may display an expected period as illustrated in FIG. 13.

In S609, the information processing server 100 adjusts the task evaluation value on the basis of the accumulated value of the task evaluation values. The process of adjusting the task evaluation value corresponds to varying the value of the evaluation adjustment value 804 described above. That is, the information processing server 100 varies the task evaluation value 803 imparted to each task according to the task processing status of the user. For example, in a case where the processing status of a specific type of task of the user (for example, the same or the same type of task) is in a state where the number of processing times is small, the information processing server 100 can prompt the user to process the task by increasing the evaluation adjustment value of the set task for the user.

The information processing server 100 may adjust the evaluation adjustment value of the set task for the user according to the task processing status of another user. For example, in a case where the processing status of a specific type of task of the user (for example, the same or the same type of task) is in a state of being higher than the processing frequency of the specific type of task of another user, the evaluation adjustment value of the set task for the user may be increased. As a result, it is possible to give a higher motivation to the user by increasing the evaluation adjustment value of the task which the user is good at.

Alternatively, the information processing server 100 may set a new task to the user according to the task processing status of the user. For example, in a case where the processing status of a specific type of task of the user (for example, the same or the same type of task) is in a state of being higher than the processing frequency of the specific type of task of another user, the task is a task that can be executed more efficiently by the user. In this case, the user may be preferentially set the specific type of task as compared with another user. In this way, an appropriate task can be assigned to the user according to the task processing status of the user.

In such a case, not only the evaluation values of the same or the same type of tasks are adjusted, but also a task having a higher difficulty level (and a higher task evaluation value) than the task of another user may be set to the user.

In S610, the information processing server 100 determines whether the accumulated value of the task evaluation values of the user is equal to or more than the target evaluation value, and changes the user status of the user when the accumulated value of the task evaluation values of the user is equal to or more than the target evaluation value. The user status indicates, for example, whether it is a “before achieving the target” state in which the user cannot obtain a desired product/service, or a “target achieved” state in which the user can acquire a specific product or receive a specific service (by achieving the target evaluation value). When the accumulated value of the task evaluation values of the user is equal to or more than the target evaluation value, the information processing server 100 changes the user status from the “before achieving the target” state to the “target achieved” state, and transmits the changed user status to the user communication device 103. Of course, the information processing server 100 may transmit information including the changed user status to a mail address of the user in addition to the user communication device 103 or may display the information on a website.

In S611, the user communication device 103 displays the received user status on the display unit 417. The user having the user status of the “target achieved” state performs a procedure for receiving the product/service, for example, making a reservation for visiting the service provider and receiving the product/service from the user communication device 103.

Note that, in a case where the user visits the service provider, the user presents the screen indicating, for example, the “target achieved” state to the operator 104 of the service provider. The operator 104 of the service provider can deliver the product/service to the user after checking the user status of the user in the service-provider communication device 105. In the above-described example, for example, when the user achieves the target evaluation value for the vehicle, the service provider can deliver the vehicle that has been rented to the user.

[Series of Operations of User Evaluation Management Process]

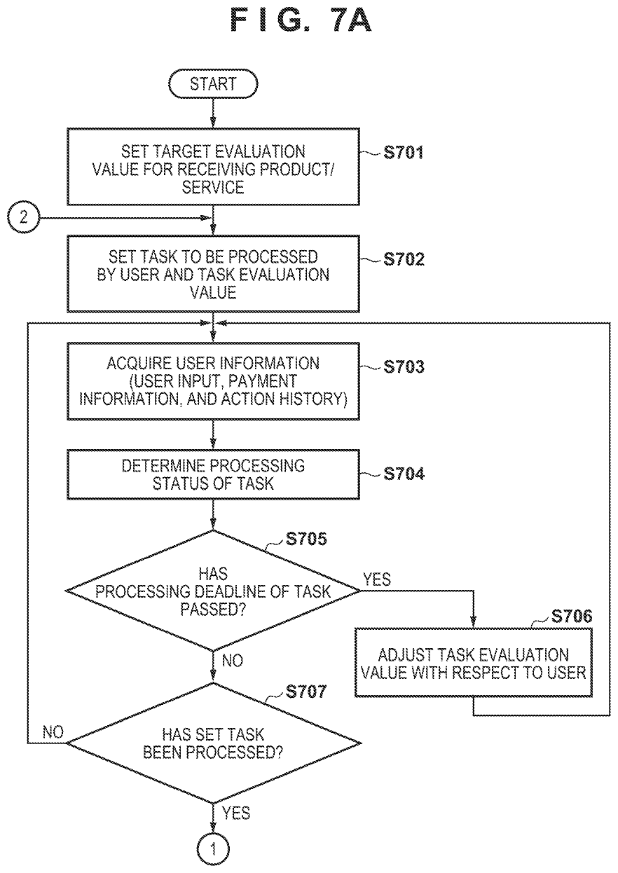

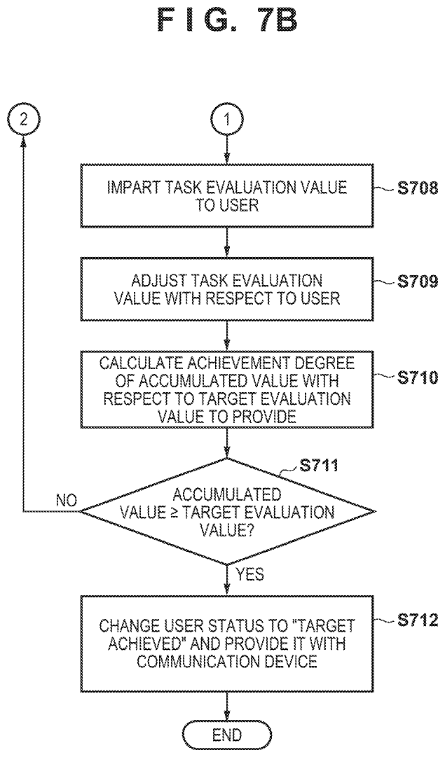

Next, a series of operations of the user evaluation management process of the information processing server 100 according to the present embodiment will be described with reference to FIGS. 7A and 7B. In the present embodiment, the CPU 201 of the information processing server 100 reads and executes a program stored in the HDD 202 to implement the present process. Each processing step is implemented by cooperation of, for example, the parts in FIG. 2 and each processing unit in FIG. 3. However, here, for the sake of simplicity, each processing step will be comprehensively described as being performed by the information processing server 100. Note that the present process is started when the user designates a desired product/service (for example, the specific vehicle “XXY1”) in a state where the “product/service selection screen” is displayed on the display unit 417 of the user communication device 103 as illustrated in FIG. 12, and information of the specified product is transmitted from the user communication device 103 to the information processing server 100.

The information processing server 100 acquires the product/service (for example, the vehicle “XXY1”) designated in the user communication device 103, associates the product/service with the user, and sets a target evaluation value for the product/service. The information processing server 100 stores, for example, information of the user ID 901, the target evaluation value 902, and the target setting date 904 (that is, the date of the present process) in the user evaluation value DB 312 illustrated in FIG. 9. At this time, the information processing server 100 initializes the accumulated value 903 to zero.

In S702, the information processing server 100 sets a task to be processed by the user and a task evaluation value. For example, the information processing server 100 can acquire user information according to a questionnaire, action history information, or a processing status of a task, and can hold information of an action range or an action time of the user. In this case, a plurality of tasks that can be executed by the user may be selected on the basis of the action range or the action time of the user from the task information stored in the task information DB 310 in advance. Then, the information processing server 100 may transmit the information of the plurality of selected tasks to the user communication device 103 and acquire the information of the task designated by the user from the user communication device 103. In this case, the designated task and the corresponding task evaluation value are registered in the set task DB 311.

As described in the above S609, in a case where the processing status of the task by the user is accumulated in the information processing server 100, the information processing server 100 may select a new task for the user according to the task processing status of the user, and set the selected task (with or without approval of the user).

In this example, the task selectable by the information processing server 100 is temporarily selected on the basis of the information of the user, and then the task is designated by the user. In this way, the user can easily designate the task to be processed by the user. However, all of the selectable tasks may be provided to the user and designated by the user. Note that the information processing server 100 can transmit information of a plurality of tasks to the user communication device 103 at an arbitrary frequency or timing.

In S703, the information processing server 100 acquires the user information. As described above, the user information includes information of a processing result of a task received from the user communication device 103, traveling data uploaded from the vehicle 101, payment information of the user, information regarding the evaluation input for the driving of the user 102, and the like. These pieces of information do not need to be acquired at a time, and may be acquired individually.

In S704, the information processing server 100 determines the processing status of the task. For example, in a case where the acquired user information is the information of a processing result of a task, the information processing server 100 determines the processing status of the task on the basis of the information. Furthermore, in a case where the acquired user information is the payment information, when there is a task related to a corresponding payment among the tasks set for the user, the task related to the corresponding payment can be determined to be in a processed status.

In S705, the information processing server 100 determines whether the task to be processed has passed a processing deadline (for example, the processing deadline 802). In a case where it is determined that the processing target task has passed the processing deadline, the information processing server 100 adjusts the task evaluation value in S706. In S706, the set task has not been processed within a predetermined deadline, and thus the task evaluation value is adjusted to decrease the task evaluation value imparted to the user or to be imparted in the future. Specifically, as illustrated in FIG. 8, the evaluation adjustment value is made negative to subtract the task evaluation value. Thereafter, the information processing server 100 returns the processing to S703.

Note that, in the present embodiment, a case where the task evaluation value is adjusted, and the processing in and after S703 is repeated in a case where the task is not processed within the predetermined period has been described as an example. However, after the process of S706 is executed, the processing may be returned to S702 to set a new task. In this case, in S702, a new task different from the task in which the adjustment value has been subtracted may be set. In this way, the user can be relieved by setting a task of recovering the subtracted evaluation value.

In S707, in a case where in the determination process in S704, the information processing server 100 determines that the set task has been processed, the processing proceeds to S708, and otherwise, the processing returns to S703.

In S708, the information processing server 100 imparts the task evaluation value to the user. As described above in S606, the process of imparting the task evaluation value can be performed by adding the value of the task evaluation value 803 to the accumulated value 903 of the user evaluation values.

In S709, the information processing server 100 adjusts the task evaluation value for the user.

The task evaluation value for the user can be adjusted by varying the value of the evaluation adjustment value 804 as described above in S609.

In addition to the process described above in S609, the adjustment value may be increased or decreased for the user in further consideration of at least one of the driving information acquired in the vehicle driven by the user and the position information of the vehicle driven by the user. For example, when the number of times of sudden acceleration/sudden deceleration or traveling at a speed exceeding a legal speed from the traveling data is less than a predetermined number of times, it may be determined that the user has an excellent driving action or action history, and the adjustment value may be increased. In addition, for example, also in a case where the position information of the vehicle driven by the user indicates that the number of times of visiting a dangerous region is equal to or less than a predetermined number of times, it may be determined that the behavior of the user is excellent, and the adjustment value may be increased.

In S710, the information processing server 100 calculates an achievement degree of the accumulated value with respect to the objective evaluation value, and provides the information of the calculated achievement degree to the user communication device 103. The information processing server 100 calculates the achievement degree by the process of S607 described above, and provides the information of the calculated achievement degree and the like to the user communication device 103.

In S711, the information processing server 100 determines whether the accumulated value 903 of the task evaluation values is equal to or more than the target evaluation value. Note that this process may be performed before S710. When determining that the accumulated value 903 of the task evaluation values is equal to or more than the target evaluation value, the information processing server 100 advances the processing to S712. In a case where it is determined not to be equal to or more than the target evaluation value, the processing returns to S702 so that the user processes (executes) a further task.

In S712, the accumulated value 903 of the task evaluation values is equal to or more than the target evaluation value, and thus the information processing server 100 changes the user status of the user from the “before achieving the target” state to the “target achieved” state as described above in S610. Then, the information processing server 100 transmits the changed status of the user to the user communication device 103. Thereafter, when the user status of the user is requested from the service-provider communication device 105, the information of the user status is transmitted to the service-provider communication device 105. Thereafter, the information processing server 100 ends a series of operations related to the present process.

Note that, in the above description, an example has been described in which the user receives a vehicle rental, accumulates the task evaluation value while paying the rental cost, and receives delivery of the rental vehicle according to the accumulated task evaluation value. However, the present embodiment is not limited to the example of receiving delivery of the vehicle. That is, for other products other than the vehicle, the task evaluation value may be accumulated while paying the rental cost, and delivery may be performed according to the accumulated task evaluation.

### SUMMARY OF EMBODIMENTS

1. An information processing server (for example, FIGS. 2 and 3) according to the above embodiments includes:

a target evaluation value setting unit (for example, 201, S701) that sets a target evaluation value which is an evaluation value necessary for a user to receive provision of a specific product or a specific service;

a task setting unit (for example, 201, S702) that sets one or more tasks to be processed by the user and a task evaluation value which is an evaluation value obtained by processing of each task;

an imparting unit (201, S708) that imparts the task evaluation value to the user according to a processing status of a task by the user;

an achievement degree calculation unit (for example, 201, S710) that calculates an achievement degree of an accumulated value of the task evaluation values imparted to the user with respect to the target evaluation value; and

a providing unit (for example, 201, S712) that provides information regarding the achievement degree to a communication device used by the user or a service provider.

According to the present embodiment, the service provider can provide a flexible service to the user on the basis of the evaluation on the action of the user.

2. In the information processing server of the above embodiments,

the target evaluation value setting unit sets the target evaluation value according to the specific product or the specific service designated by the user. More specifically, for example, information indicating the selection result of the user may be received, and the target value may be set on the basis of the information.

According to the present embodiment, the service provider can provide the product or service desired by the user by enabling the user to designate the desired product or service.

3. In the information processing server of the above embodiments,

the task setting unit is capable of setting (for example, 302) a plurality of types of tasks including a task of paying a consideration for a service and a task of a type different from the consideration payment, and

the achievement degree calculation unit calculates an achievement degree of an accumulated value of a sum of the task evaluation values obtained by the processing of the tasks with respect to the target evaluation value.

According to the present embodiment, the task evaluation value is imparted to the user also by processing a task of a type different from the task of paying the consideration, and thus the task evaluation value can be supplemented by processing different types of tasks.

4. In the information processing server of the above embodiments,

the task setting unit determines an executable task for the user on the basis of a task processing status of the user or the task evaluation value imparted to the user, and then sets the one or more tasks (for example, S702).

According to the present embodiment, it is possible to assign an appropriate task to the user according to the task processing status of the user.

5. In the information processing server of the above embodiments,

the task setting unit varies a value of the task evaluation value obtained by future processing of a specific type of task on the basis of a past processing status of the specific type of task by the user (for example, S706).

According to the present embodiment, even for the same type of tasks, the evaluation value can be increased or decreased according to the task processing status of the user. For a user who is good at processing a specific task, a task of a similar type with the task can be set. Alternatively, a task having a high difficulty level and a high point can be assigned to a user having a high processing result, and a task having a simpler and lower point can be imparted to a user having a low processing result.

6. In the information processing server of the above embodiments,

the task setting unit varies a value of the task evaluation value obtained by processing of a specific type of task by the user on the basis of a processing status of the specific type of task by another user (for example, S706).

According to the present embodiment, it is possible to increase or decrease the task evaluation value according to the task processing status of another user. As a result, for example, for a predetermined task which is less processed by another user, the processing of the predetermined task can be prompted by increasing the evaluation value of the predetermined task.

7. In the information processing server of the above embodiments,

the achievement degree calculation unit further calculates information regarding a guide for achieving the target evaluation value on the basis of the task evaluation value imparted to the user (for example, S607).

According to the present embodiment, it is possible to know when the service or the product can be purchased and to increase motivation of the user.

8. The information processing server of the above embodiments further includes:

a subtraction unit that determines whether a set task has been processed within a predetermined deadline, and decreases the task evaluation value imparted to the user or to be imparted in future in a case where it is determined that the set task has not been processed within the predetermined deadline.

According to the present embodiment, it is possible to prompt the processing of the task.

9. In the information processing server of the above embodiments,

in a case where the task evaluation value is decreased by the subtraction unit, the task setting unit sets a new task different from the task set for the user.

According to the present embodiment, the user can be relieved by setting the task of recovering the subtracted evaluation value.

10. In the information processing server of the above embodiments,

the imparting unit imparts the task evaluation value to the user in further consideration of at least one of driving information acquired in a vehicle driven by the user and position information of the vehicle driven by the user.

According to the present embodiment, a higher task evaluation value can be imparted to a user having an excellent driving action and action history.

11. In the information processing server of the above embodiments,

in a case where the accumulated value of the task evaluation values imparted to the user exceeds the target evaluation value, a status of the user is changed to a status in which the user is capable of acquiring the specific product or receiving the specific service.

According to the present embodiment, the status of the user can be browsed from the user communication device and the service-provider communication device of the service provider, and the specific service or product can be provided by the service provider.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The invention is not limited to the foregoing embodiments, and various variations/changes are possible within the spirit of the invention.

What is claimed is:

1. An information processing server comprising:
one or more processors; and
a memory storing instructions which, when the instructions are executed by the one or more processors, cause the information processing server to function as:
a target evaluation value setting unit that sets a target evaluation value which is an evaluation value necessary for a user to receive provision of a specific product or a specific service;
a task setting unit that sets one or more tasks to be processed by the user and a task evaluation value which is an evaluation value obtained by processing of each task;
an imparting unit that imparts the task evaluation value to the user according to a processing status of the user with respect to a task set by the task setting unit;
an achievement degree calculation unit that calculates an achievement degree of an accumulated value of the task evaluation values imparted to the user with respect to the target evaluation value; and
a providing unit that provides information regarding the achievement degree to a communication device used by the user or a service provider,
wherein the task setting unit is capable of setting a plurality of types of tasks including a task of paying a consideration for a service and a task of a type different from the consideration payment, and
the achievement degree calculation unit calculates an achievement degree of an accumulated value of a sum of the task evaluation values obtained by the processing of the tasks with respect to the target evaluation value.

2. The information processing server according to claim 1, wherein the task setting unit determines an executable task for the user on a basis of a task processing status of the user or the task evaluation value imparted to the user, and then sets the one or more tasks.

3. The information processing server according to claim 1, wherein the task setting unit varies a value of the task evaluation value obtained by future processing of a specific type of task on a basis of a past processing status of the specific type of task by the user.

4. The information processing server according to claim 1, wherein the task setting unit varies a value of the task evaluation value obtained by processing of a specific type of task by the user on a basis of a processing status of the specific type of task by another user.

5. The information processing server according to claim 1, further comprising a subtraction unit that determines whether a set task has been processed within a predetermined deadline, and decreases the task evaluation value imparted to the user or to be imparted in future in a case where it is determined that the set task has not been processed within the predetermined deadline,
wherein in a case where the task evaluation value is decreased by the subtraction unit, the task setting unit sets a new task different from the task set for the user.

6. The information processing server according to claim 1, wherein the target evaluation value setting unit sets the target evaluation value according to the specific product or the specific service designated by the user.

7. The information processing server according to claim 1, wherein the achievement degree calculation unit further calculates information regarding a guide for achieving the target evaluation value on a basis of the task evaluation value imparted to the user.

8. The information processing server according to claim 1, wherein the imparting unit imparts the task evaluation value to the user in further consideration of at least one of driving information acquired in a vehicle driven by the user and position information of the vehicle driven by the user.

9. The information processing server according to claim 1, wherein in a case where the accumulated value of the task evaluation values imparted to the user exceeds the target evaluation value, a status of the user is changed to a status in which the user is capable of acquiring the specific product or receiving the specific service.

10. An information processing method executed in an information processing server, the method comprising:
a target evaluation value setting step of setting a target evaluation value which is an evaluation value necessary for a user to receive provision of a specific product or a specific service;
a task setting step of setting one or more tasks to be processed by the user and a task evaluation value which is an evaluation value obtained by processing of each task;
an imparting step of imparting the task evaluation value to the user according to a processing status of the user with respect to a task set in the task setting step;
an achievement degree calculation step of calculating an achievement degree of an accumulated value of the task evaluation values imparted to the user with respect to the target evaluation value; and
a providing step of providing information regarding the achievement degree to a communication device used by the user or a service provider,
wherein in the task setting step, setting a plurality of types of tasks including a task of paying a consideration for a service and a task of a type different from the consideration payment is capable, and
in the achievement degree calculation step, an achievement degree of an accumulated value of a sum of the task evaluation values obtained by the processing of the tasks with respect to the target evaluation value is calculated.

11. The information processing method according to claim 10, wherein in the task setting step, an executable task for the user is determined on a basis of a task processing status of the user or the task evaluation value imparted to the user, and then the one or more tasks are set.

12. The information processing method according to claim 10, wherein in the task setting step, a value of the task evaluation value obtained by future processing of a specific type of task is varied on a basis of a past processing status of the specific type of task by the user.

13. The information processing method according to claim 10, wherein in the task setting step, a value of the task evaluation value obtained by processing of a specific type of task by the user is varied on a basis of a processing status of the specific type of task by another user.

14. The information processing method according to claim 10, further comprising a subtraction step of determining whether a set task has been processed within a predetermined deadline, and decreasing the task evaluation value imparted to the user or to be imparted in future in a case where it is determined that the set task has not been processed within the predetermined deadline,
wherein in a case where the task evaluation value is decreased in the subtraction step, in the task setting step, a new task different from the task set for the user is set.

15. A non-transitory computer readable storage medium storing a program,
the program is executed by one or more processors of an information processing server to cause the processors to execute:
a target evaluation value setting step of setting a target evaluation value which is an evaluation value necessary for a user to receive provision of a specific product or a specific service;
a task setting step of setting one or more tasks to be processed by the user and a task evaluation value which is an evaluation value obtained by processing of each task;
an imparting step of imparting the task evaluation value to the user according to a processing status of the user with respect to a task set in the task setting step;
an achievement degree calculation step of calculating an achievement degree of an accumulated value of the task evaluation values imparted to the user with respect to the target evaluation value; and
a providing step of providing information regarding the achievement degree to a communication device used by the user or a service provider,
wherein in the task setting step, setting a plurality of types of tasks including a task of paying a consideration for a service and a task of a type different from the consideration payment is capable, and
in the achievement degree calculation step, an achievement degree of an accumulated value of a sum of the task evaluation values obtained by the processing of the tasks with respect to the target evaluation value is calculated.

16. The non-transitory computer readable storage medium according to claim 15, wherein in the task setting step, an executable task for the user is determined on a basis of a task processing status of the user or the task evaluation value imparted to the user, and then the one or more tasks are set.

17. The non-transitory computer readable storage medium according to claim 15, wherein in the task setting step, a value of the task evaluation value obtained by future processing of a specific type of task is varied on a basis of a past processing status of the specific type of task by the user.

18. The non-transitory computer readable storage medium according to claim 15, wherein in the task setting step, a value of the task evaluation value obtained by processing of a specific type of task by the user is varied on a basis of a processing status of the specific type of task by another user.

19. The non-transitory computer readable storage medium according to claim 15, further comprising a subtraction step of determining whether a set task has been processed within a predetermined deadline, and decreasing the task evaluation value imparted to the user or to be imparted in future in a case where it is determined that the set task has not been processed within the predetermined deadline,
wherein in a case where the task evaluation value is decreased in the subtraction step, in the task setting step, a new task different from the task set for the user is set.

20. A service provision support system comprising: an information processing server; and a communication device, wherein
the information processing server includes
a target evaluation value setting unit that sets a target evaluation value which is an evaluation value necessary for a user to receive provision of a specific product or a specific service,
a task setting unit that sets one or more tasks to be processed by the user and a task evaluation value which is an evaluation value obtained by processing of each task,
an imparting unit that imparts the task evaluation value to the user according to a processing status of the user with respect to a task set by the task setting unit,
an achievement degree calculation unit that calculates an achievement degree of an accumulated value of the task evaluation values imparted to the user with respect to the target evaluation value, and
a first providing unit that provides information regarding the achievement degree to a communication device used by the user or a service provider,
wherein the task setting unit is capable of setting a plurality of types of tasks including a task of paying a consideration for a service and a task of a type different from the consideration payment, and
the achievement degree calculation unit calculates an achievement degree of an accumulated value of a sum of the task evaluation values obtained by the processing of the tasks with respect to the target evaluation value, and
the communication device includes
a second providing unit that provides information for designating the specific product or the specific service to the information processing server, and
an acquisition unit that acquires the information regarding the achievement degree from the information processing server.

21. The service provision support system according to claim 20, wherein the task setting unit of the information processing server determines an executable task for the user on a basis of a task processing status of the user or the task evaluation value imparted to the user, and then sets the one or more tasks.

22. The service provision support system according to claim 20, wherein the task setting unit of the information processing server varies a value of the task evaluation value obtained by future processing of a specific type of task on a basis of a past processing status of the specific type of task by the user.

23. The service provision support system according to claim 20, wherein the task setting unit varies a value of the task evaluation value obtained by processing of a specific type of task by the user on a basis of a processing status of the specific type of task by another user.

24. The service provision support system according to claim 20, wherein the information processing server further comprises a subtraction unit that determines whether a set task has been processed within a predetermined deadline, and decreases the task evaluation value imparted to the user or to be imparted in future in a case where it is determined that the set task has not been processed within the predetermined deadline,
wherein in a case where the task evaluation value is decreased by the subtraction unit, the task setting unit sets a new task different from the task set for the user.
